(19) United States
(12) Patent Application Publication
(10) Pub. No.: US 2006/0020493 A1
(43) Pub. Date: Jan. 26, 2006

(54) Ontology based method for automatically generating healthcare billing codes from a patient encounter

(76) Inventors: Leo E. Cousineau, Edgewater, MD (US); Peter L. Cherpes, Haymarket, VA (US); Ravindra R. Brewster, Arlington, VA (US); Harry Young, Rockvale, TN (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/186,762

(22) Filed: Jul. 22, 2005

Related U.S. Application Data
(63) Continuation-in-part of application No. 11/034,937, filed on Jan. 14, 2005.
(60) Provisional application No. 60/591,229, filed on Jul. 26, 2004.
(60) Provisional application No. 60/624,715, filed on Nov. 3, 2004.

(51) Int. Cl. G06Q 10/00

(52) U.S. Cl. 705/2

(57) ABSTRACT

A healthcare related method corrects on non-standard input data in a syntax processing block with reference to one or more healthcare lexicons, and a resulting corrected data file is thereafter used by an ontology processing block to reference an ontology and generate a standardized output including one or more healthcare billing codes.

This application is a continuation-in-part of U.S. patent application Ser. No. 11/034,937 filed on Jan. 14, 2005 and claims the benefit of U.S. Provisional Application No. 60/591,229 filed Jul. 26, 2004 and U.S. Provisional Application No. 60/624,715 filed Nov. 3, 2004.

### BACKGROUND OF THE INVENTION

1. Field of the Invention

The invention relates generally to data capture and standardized healthcare-related knowledge representation. More specifically, the invention relates to an ontology-based method capable of transforming non-standard input data related to a patient encounter into a standardized output including one or more healthcare billing codes.

2. Description of the Related Art

There continues to be an explosion of information in nearly every area of human endeavor. Two major problems confronting information system designers are (1) how to efficiently capture and store this wealth of information in digital media, and, (2) how to organize and/or communicate the information in such a way that it is useful and meaningful to human users and other digital systems and devices.

A great deal of research has focused on developing effective automated methods for capturing and encoding data from a wide range of sources such as paper documents, photographs, digital images, audio data, and so forth. Some of the technologies resulting from this research include voice recognition systems, optical character recognition systems, and image processing systems, to name but a few. Many of these technologies have reached the point where they can reliably recognize and extract data primitives such as words, sentences, shapes, or even human faces from raw, unstructured input data.

Still other research has focused on taking data which has already been captured and encoded, and representing the data in such a way that it is easily interpreted by various agents, such as computer users, search engines, routers, spread sheet applications, statistical engines, etc. Conventional approaches to solving this problem include, for example, indexing schemes which identify or highlight important features in stored data. For example, an image containing a green triangle may be digitally tagged with an identifier of “green triangle” so that a search engine seeking to locate images containing a green triangle can do so by simply examining image tags. Likewise, textual data can be tagged with identifiers, which may include, for example, key words selected from text data.

More advanced conventional approaches to this problem, however, focus on providing a formal representation of the input data's semantic content, i.e. some indication of the input data's meaning. Providing a formal representation of the input data's semantic content is beneficial to agents receiving and processing the data because it allows them to reason, (e.g., calculate, make determinations, or construct higher order data structures) in relation to the input data using conceptual or higher order terms. Hence, an accurate and appropriate formal representation of the input data enables agents to make well informed high-level decisions.

A formal representation of input data's semantic content is provided, for example, by an ontology. In this context, an ontology is a structured representation of agreements about a set of concepts that characterize the data. The content, structure, and implementation of an ontology can vary widely. However, an ontology generally comprises a plurality of related concepts linked together in a hierarchical manner (e.g., using “IS_A” relationships) to form a taxonomy, and thereafter enriched with additional higher-order relationships between taxonomy concepts to enable the expression of specific knowledge. The concept “higher-order relationships” should be broadly construed to cover all relationships, constraints, and rules having greater complexity than a simple single relationship, such as “IS_A”.

An ontology is defined in relation to a particular domain. For example, the University of Washington School of Medicine has defined a Foundational Model of Anatomy in the domain of life science which provides a framework for describing various properties, behaviors, and relationships of components and concepts relative to the human body. (See, http://sig.biostr.washington.edu/projects/fm/AboutFM.html). An ontology is defined with respect to a particular domain for various reasons. One reason is so the ontology can represent a very specific set of interrelated concepts. Another reason is so concepts which are denoted by similar terms in different domains can be represented unambiguously.

An ontology is a particularly desirable way of representing knowledge in computer system applications because it allows for transparent communication between different hardware platforms and software applications. In other words, since an ontology provides an explicit formal representation of the semantic content of data, rather than relying on ad hoc techniques such as tagging, indexing, or hashing, the data represented using an ontology may be readily transferred between different systems.

Presently, there is a high level of interest in developing a system and method of automatically generating healthcare billing codes from data produced by a patient encounter with a healthcare provider. The generation of healthcare billing codes using an automated system would be a great benefit to the healthcare providers because it would significantly reduce the time and cost that physicians and other healthcare providers expend filling out paperwork.

A number of approaches have been suggested for assimilating and/or processing data from a patient encounter in order to generate healthcare billing codes.

U.S. Pat. No. 6,529,876 discloses an electronic template medical records coding system. A healthcare provider selects an appropriate electronic template stored on a computer, depending upon a patient encounter category or type of patient encounter, and inputs data from the patient encounter into corresponding data entry fields, with the computer then analyzing the data and generating therefrom an Evaluation and Management (E&M) billing code.

U.S. Patent Publication 2004/0176979 discloses a method and system of analyzing a medical form marked by a healthcare provider during a patient encounter to generate a billing code. For each patient encounter, the healthcare provider obtains a preprinted form having a number of predefined data entry fields, and is required to enter data into the appropriate data entry fields on the form during the patient encounter. Alternatively, the form may be presented electronically on a portable computing device (e.g., tablet PC). Then, the completed form is scanned into a computer and the data is each field is analyzed to generate an E&M billing code.

In the above approaches, as well as many other conventional systems integrating data capture and knowledge representation, there are shortcomings. One shortcoming is that the various components forming the system are highly interdependent. That is, the system's overall ability to accurately capture data influences the system's ability to represent the semantic content of the data. For example, where a healthcare provider enters data into the wrong data entry field, the system is unlikely to detect the error and deduce the proper field for the data. Likewise, in some cases a system's ability to accurately represent the semantic content of the data influences the system's ability to accurately capture the data. Conventionally, since the system components are interdependent, it is inappropriate to simply combine some component performing data capture with some other component performing knowledge representation without further specifying a certain degree of cooperative relationship between the components. Hence, respective conventional systems tend to be quite narrow in their application and are ill-adapted to interoperability.

Another shortcoming noted in conventional systems is the requirement that data be entered in a standardized form. The systems require that the data be very specifically entered in the correct, predefined fields. These systems are unable to process non-standard input data, such as a free-form voice record generated during a patient encounter. Accordingly, they are time-intensive and place a data entry burden on the healthcare provider.

It would be desirable, therefore, to provide a method capable of receiving unstructured (hereafter, “non-standard”) input data, encoding the data in an appropriate format, and providing a rich and accurate representation of the semantic content of the input data. It would further be desirable to provide such a method capable of automatically generating one or more appropriate healthcare billing codes from the non-standard input data.

### SUMMARY OF THE INVENTION

In one aspect of the invention, a method of generating healthcare billing codes, comprises: generating non-standard data during a patient encounter with a healthcare provider; receiving the non-standard data in a syntax processing block and, in response to the non-standard data, generating a corrected data file with reference to a healthcare lexicon; and, receiving the corrected data file in an ontology processing block and, in response to the corrected data file, generating standardized output data including one or more healthcare billing codes associated with the patient encounter.

Beneficially, the healthcare billing code(s) include at least one of a medical diagnosis code and a healthcare procedure code. Advantageously, the healthcare procedure code belongs to a set of codes in Current Procedure Terminology, Yth Edition (Y≧4), and the medical diagnosis code belongs to a set of codes in the International Classification of Diseases, Xth edition (X≧9). Optionally, the standardized output is formatted in accordance with a healthcare services claim form, which advantageously may be a CMS-1450 or a HCFA-1500 claim form. The output may include a partially-completed healthcare services claim form, with one or more billing codes placed in the appropriate field(s).

The non-standard input data may include at least one of voice, handwriting, text, image data, and an electronic file, and the syntax processing block may include at least one of a voice recognition application, a forms recognition application, an image recognition application, and a file parsing application, any one of which may access the healthcare lexicon.

In a related aspect, the syntax processing block comprises a capture block wirelessly (or wired) connected to a staging block. For example, the capture block may include a wireless microphone generating a voice transcript signal, and the staging block may include a digital logic platform receiving the voice transcript signal and generating the corrected data file in response to the voice transcript signal with reference to the healthcare lexicon. The digital logic platform may take many forms, including but not limited to a Personal Computer (PC), a tablet PC, a laptop PC, or a Personal Digital Assistant (PDA).

In one embodiment, the digital logic platform comprises memory and computational logic adapted to run a capture application enabling receipt of the voice transcript signal and generation of a voice data file from the voice transcript signal, and a syntax application generating the corrected data file from the voice data file with reference to the healthcare lexicon.

A data communication link connecting the syntax processing block and the ontology processing block may be comprised of one or more of the following: a Wireless Local Area Network (WLAN), a Wireless Metropolitan Area Network (WMAN), an ad-hoc wireless network, a hardwired Local Area Network (LAN), or an Ethernet connected network.

The digital logic platform used in one embodiment comprises memory and computational logic adapted to run a syntax application generating the corrected data file from the voice data file with reference to the one or more healthcare lexicons. The syntax application may further include a criteria-correction subroutine correcting the voice data file in accordance with a criteria defining content for the corrected data file. In a more specific embodiment of the syntax application, the criteria-correction subroutine implements a voice activated, control grammar application directing the receipt of voice input data and providing feedback to the user in relation to the voice data input.

In another aspect of the invention, a method comprises: receiving with a wireless microphone system non-standard voice input data relating to a patient encounter, and in response thereto generating a voice transcript signal; wirelessly communicating the voice transcript signal to a digital logic platform and generating a corrected data file in response to the voice transcript signal and with reference to a healthcare lexicon; communicating the corrected data file to a server; referencing an ontology in relation to the corrected data file; and generating a standardized output, including one or more healthcare billing codes, in response to the referencing of the ontology in relation to the corrected data file.

In yet another aspect of the invention, a method, comprises: receiving non-standard voice input data produced as a result of a patient encounter with a healthcare provider; processing the non-standard voice input data through a syntax processing block to generate a corrected data file with reference to a healthcare lexicon; and processing the corrected data file with reference to a billing code ontology to generate standardized output data including at least one healthcare billing code pertaining to the patient encounter.

Beneficially, processing the non-standard voice input data includes performing a speech recognition algorithm on the voice input data with reference to the healthcare lexicon.

In one embodiment, the method includes receiving user feedback to an output of the speech recognition algorithm. In that case, beneficially the method also comprises further correcting the output of the speech recognition algorithm to produce the corrected data file.

### BRIEF DESCRIPTION OF THE DRAWINGS

The invention is described below in relation to several embodiments illustrated in the accompanying drawings. Throughout the drawings like reference numbers indicate like exemplary elements, components, or steps. In the drawings:

FIG. 1 is a broad conceptual illustration of an ontology based medical system for data capture and knowledge representation;

FIG. 2 is a conceptual system description illustrating one embodiment of an ontology based medical system for data capture and knowledge representation;

FIG. 3 is a flowchart illustrating an exemplary data flow through an embodiment of the invention like the one described in relation to FIG. 2;

FIG. 4 is a conceptual diagram further illustrating another embodiment of an ontology based medical system for data capture and knowledge representation in which a corrected data file is applied to multiple ontologies, including a healthcare billing code ontology;

FIG. 5 is a flowchart illustrating use of an ontology based medical system for data capture and knowledge representation in the context of a medical patient evaluation; and,

FIGS. 6A-F are flowcharts further illustrating a process of generating healthcare billing codes from a patient encounter using an ontology based medical system.

### DESCRIPTION OF THE EXEMPLARY EMBODIMENTS

The invention addresses the general need for a healthcare related method adapted to capture non-standard input data and to automatically generate therefrom a standardized output, including one or more healthcare billing codes. The standardized output is generated by reference to an ontology adapted to extract and/or define knowledge (e.g., semantic content) from a data file that accurately expresses the subject matter of the non-standard input data. Modification, processing, and/or synthesis of the non-standard input data is broadly termed “correction”, and thus the data file accurately expressing the subject matter of the non-standard input data is termed a “corrected data file.”

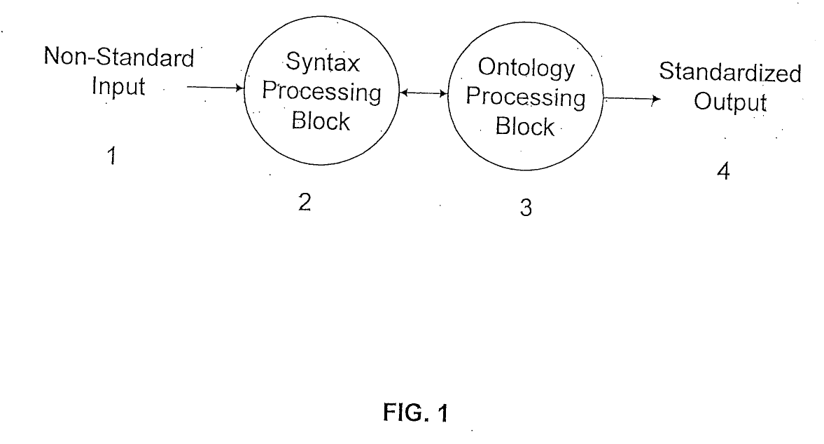

U.S. patent application Ser. No. 11/034,937 (“the '937 application”) filed on Jan. 14, 2005 discloses an ontology based method of data capture and knowledge representation, and is hereby incorporated herein by reference in its entirety for all purposes as if fully set forth herein. FIG. 1 shows a conceptual illustration of an ontology based medical system for data capture and knowledge representation, comprising a syntax processing block 2 receiving a non-standard data input 1, and generating a corrected data file which serves as an input to one or more ontology processing block 3. Ontology processing block 3 generates a standardized output 4 in relation to the corrected data. The '937 application further discloses methods of developing an ontology, and method of identifying concepts within the context of an ontology development.

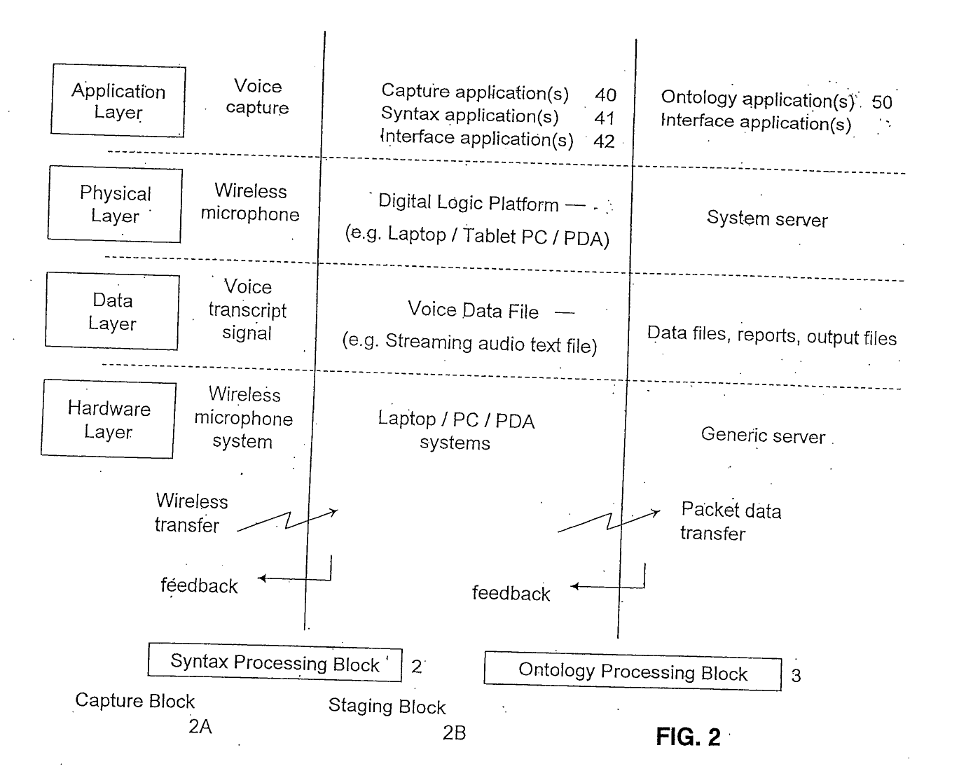

FIG. 2 illustrates one embodiment of an ontology based medical system for data capture and knowledge representation. Within this particular system, choices regarding sub-system boundaries, and hardware/software types and partitions are made in the context of the working example and are merely exemplary. Different embodiments of the invention would almost certainly result in different design choices. Furthermore, the '937 application discloses that the syntax application(s) 41 operate on a non-standard, input data file between capture application 40 and an interface applications 42. By operation of the staging block 2B in cooperation with the capture block 2A, a corrected data file is generated in response to the non-standard voice data input by the healthcare practitioner. Once completed, this corrected data file is communicated to the ontology processing block 3.

One or more ontologies and related ontology application(s) 50 in the application layer form the heart of ontology processing block 3. In some embodiments of the invention, the ontology will be coupled with a Natural Language Processing (NLP) application, a Natural Language Understanding (NLU) application, or similar computational linguistics application. Alternatively, language processing capability may be incorporated in the syntax processing block. NLP applications and their like are conventional and generally apply computational models to better understand and characterize natural language. Such applications are particularly valuable where a free-form human voice input is expected to interface with a digital logic system.

An optional, but potentially valuable aspect of the system is indicated by the separate feedback arrows shown in FIG. 2. By including such feedback, continual incremental improvements in the cooperation between capture block 2A and staging block 2B, and between syntax processing block 2 and ontology processing block 3, can be provided. Feedback from staging block 2B to capture block 2A may take the form of visual user feedback (e.g., grouped data elements), whereby the healthcare practitioner sees on a visual display the results or system reaction to his/her voice input. This type of feedback is particularly important where the voice data is subject to criteria correction by the staging block 2B. Feedback from ontology processing block 3 to syntax processing block 2 may take many forms including packet data transmission statistics, data file errors, or “learning” or context information indicating correction refinement or adjustments.

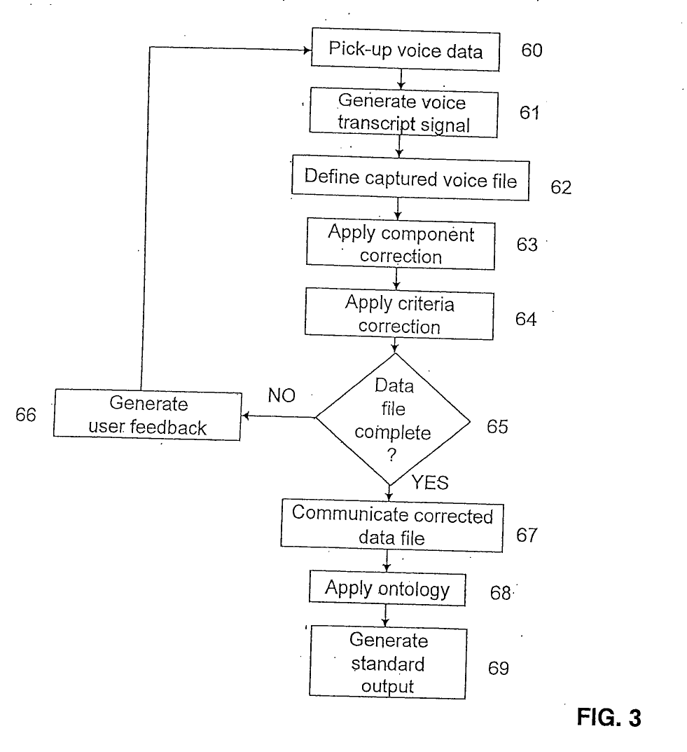

FIG. 3 is a flowchart illustrating an exemplary data flow through a system like the one described in relation to FIG. 2. The data flow begins with a healthcare practitioner speaking freely as he/she has a patient encounter, such as an evaluation. From this flow of non-standard voice data, the exemplary system will ultimately generate a standardized billing report accurately defining one or more healthcare billing codes from the substance of the patient encounter. As the healthcare practitioner speaks, a wireless microphone picks-up the voice data (60) and generates a corresponding voice transcript signal (61). The voice transcript signal is communicated to the staging block where it is captured in a voice file (e.g., streaming audio or a text file) (62). The combination of wireless microphone and speech recognition application running in the laptop or tablet PC may be conventional. Alternatively, conventional speech recognition software may be customized via the incorporation of a healthcare-specific lexicon. That is, words and phrases normally occurring in routine conversation are processed using the conventional speech recognition application. However, where an esoteric health term or phrase is used by the healthcare practitioner, the lexicon is queried to determine the appropriate word or phrase. The use of an appropriate application to provide access to a lexicon is an excellent example of component-correction (63). That is, the selected words (i.e., components) forming a portion of the non-standard input data are correctly interpreted and defined within a corresponding data file.

At this point it should be noted that the syntax processing block may utilize an ontology of its own. Here, for example, health terms may not only be properly interpreted from the voice input data, but also associated with supplemental information derived from one or more related ontologies.

Following component correction (63), the captured voice file (now called a “data file”) may be additionally (and optionally) subjected to criteria correction (64). Where the resulting data file is not complete (65=no), feedback is generated (66) and communicated to the system user (e.g., a visual indication on the laptop PC, and/or an audio error indication). Thereafter, the user may enter additional voice data to correct the indicated problem until the data file is complete or an exception is duly noted. In this example, the patient evaluation may include certain minimal global criteria or criteria specially mandated as a result of the ongoing or previous evaluations.

Once the corrected data file is component corrected and complete as to all relevant criteria (65=yes), it is communicated to the ontology processing block (67).

Ontologies by their very nature are highly susceptible to errors resulting from erroneous inputs. That is, the concepts and relationships defining the ontology are defined in relation to input components (e.g., vocabulary terms). Accordingly, errant input components are highly likely to produce errant ontology outputs. By correcting a data file in relation to components and/or criteria, the benefits offered by the ontology are maximized.

For example, healthcare billing codes are notoriously numerous, subtle in their distinction, yet highly important for accurate financial compensation. An ontology correlating patient evaluation data with healthcare billing code data is, thus, dependent on the accuracy of the patient evaluation data. Hence, the significance of the syntax processing block between the non-standard voice input and front end of the ontology.

By applying the ontology (68) to a properly corrected data file, an accurate standardized output (e.g., one or more healthcare billing codes) may be generated (69).

As disclosed herein, the ontology forms at least part of a reference knowledge base. This reference knowledge base need only span the scope of the relevant domain. However, multiple ontologies may be applied to a single corrected data file in order to produce multiple standard outputs. In this manner, respective ontologies may be efficiently developed and maintained in relation to a properly scoped domain.

In particular, the '937 application discloses that such a system may include a billing ontology that generates a proper set of healthcare billing codes and/or internal accounting codes from the subject matter of a corrected data file, and generates a standardized billing report which may thereafter be sent to an accounting records file.

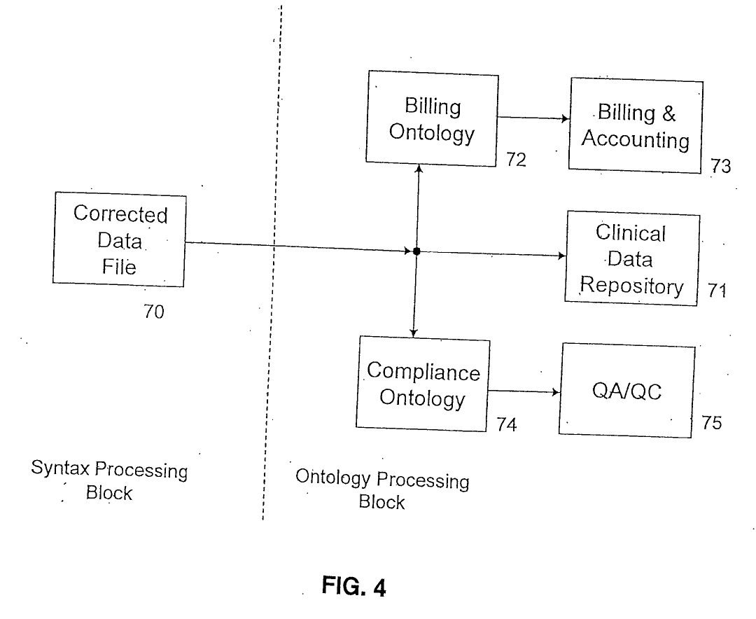

FIG. 4 is a conceptual diagram further illustrating another embodiment of an ontology based medical system for data capture and knowledge representation in which a corrected data file is applied to multiple ontologies, including a healthcare billing code ontology. A corrected data file 70 is communicated from a syntax processing block to an ontology processing block having multiple ontologies. Upon receipt in the ontology processing block, the corrected data file may be stored without further data processing in a clinical data repository 71 for future reference. The corrected data file is also passed to billing ontology 72 and compliance ontology 74. Billing ontology 72 generates a proper set of healthcare billing codes and/or internal accounting codes from the subject matter of the corrected data file and generates a standardized billing report which may thereafter be sent to an accounting records file.

The term “standardized output” has been used to describe the output of an ontology application implemented in the ontology processing block. This term should be read as encompassing any output form acceptable to an external system, whether human or machine. In the context of the healthcare billing code application, there are many standards that might serve to define the exact nature and content of the system's output, including standards established by the Health Insurance Portability & Accountability Act (HIPAA), International Classification of Diseases: t^{he} revision, Clinical Modification (ICD-X-CM) (e.g., ICD-9-CM; ICD-10-CM, etc.), Health Care Common Procedure Coding System (HCPCS) (e.g., HCPCS Level II codes), Current Procedural Terminology (CPT-Y) (e.g., CPT-4; CPT-5, etc.), Health Care Financing Administration (HCFA), Food & Drug Administration (FDA), Veterans Affairs (VA), Department of Health and Human Services (HHS), Centers for Medicare and Medicaid Services (CMS), National Library of Medicine (NLM), and the World Health Organization (WHO), etc.

The term “standard” or “standardized” in the foregoing context may have reference to either the content and/or the form factor of the resulting output. That is, in the context of the working example, the standardized output might not only include properly identified and related healthcare billing codes, but it may also be presented in a form ready for immediate consumption by downstream systems (e.g., be interface ready via HL7 or XML, etc.).

In particular, the ontology beneficially may generate as a standardized output one or more billing codes and other information necessary to complete a standard healthcare services claim form, such as a CMS-1500 (also known as HCFA-1500) Health Insurance Claim Form, or a CMS-1450 (also known as UB-92 HCFA-1450) Medicare Claim Form. Advantageously, the ontology based medical system may output data from a patient encounter in standardized form as a partially completed standard healthcare services claim form.

Such forms have a number of different fields that must be completed with pertinent codes in order for a healthcare provider to receive reimbursement from a healthcare insurer or Medicare. For purposes of illustration, consider Medicare Claim Form CMS-1450. CMS-1450 requires a healthcare provider to provide the codes shown in Table 1, below.

TABLE 1

| Field | | |
|---|---|---|
| (Form Locator) | Code Type | Code Source |
| 4 | Type of Bill | CMS Manual System |
| 19 | Type of Admission/Visit | CMS Manual System |
| 20 | Source if Admission | CMS Manual System |
| 22 | Patient Status | CMS Manual System |
| 24-30 | Condition Codes | CMS Manual System |
| 32-35 | Occurrence Codes | CMS Manual System |
| 36 | Occurrence Span Codes | CMS Manual System |
| 39-41 | Value Codes | CMS Manual System |
| 42 | Revenue Codes | CMS Manual System |
| 44 | HCPCS Codes | CPT-5/HCPCS |
| 59 | Patient Relationship Code | CMS Manual System |
| 67-76 | Diagnosis Codes | ICD-9-CM |
| 80-81 | Procedure Codes | ICD-9-CM |

Additional data is also needed to generate a complete a healthcare services claim form, such as information about the patient (name, address, sex, birth date, etc.), information about the healthcare provider (name, address, ID number, federal tax ID, etc.), insurance (provider, group number, policy number, etc.), service date(s), etc.

Advantageously, the ontology may generate some of this additional data from one or more corrected data files generated during one or more patient encounter. Also advantageously, the standardized output of the ontology may be merged with other data available in data files at a system server to generate a healthcare services claim form that is at least partially completed.

Particularly powerful embodiments of the invention may be implemented using a non-standard voice data input coupled with a speech recognition application. In a further refinement of this particular aspect, the additional provision of voice actuated control over the manner of data input is contemplated. In one related embodiment, voice actuated control may be implemented using a control grammar. The control grammar is likely to be specific to the domain or knowledge encompassed by capture and/or syntax applications running on the staging block. Control grammar implementation may even be accomplished by a separate application running on the staging block hardware platform.

In this context and throughout this disclosure, it should be noted that various application types (e.g., interface, syntax, capture, etc.) are merely arbitrary distinctions used to identify certain common functionality found in the exemplary embodiments. Those of ordinary skill in the art will recognize that a single omnibus application might implement all software functionality in the syntax processing block and/or the ontology processing block. This is, however, unlikely for practical reasons. Nonetheless, no partition boundaries between various software implemented functionalities is intended by the descriptive references to one or more applications.

Thus, beneficially, the control grammar is linked to software subroutines enabling navigation of one or more enabling applications without a requirement for the use of traditional input devices, such as keyboard entries, mouse/menu selections, etc. While such traditional input are certainly enabled in the invention, the grammar control embodiment seeks to preserve the option of completely hands-free operation of the system.

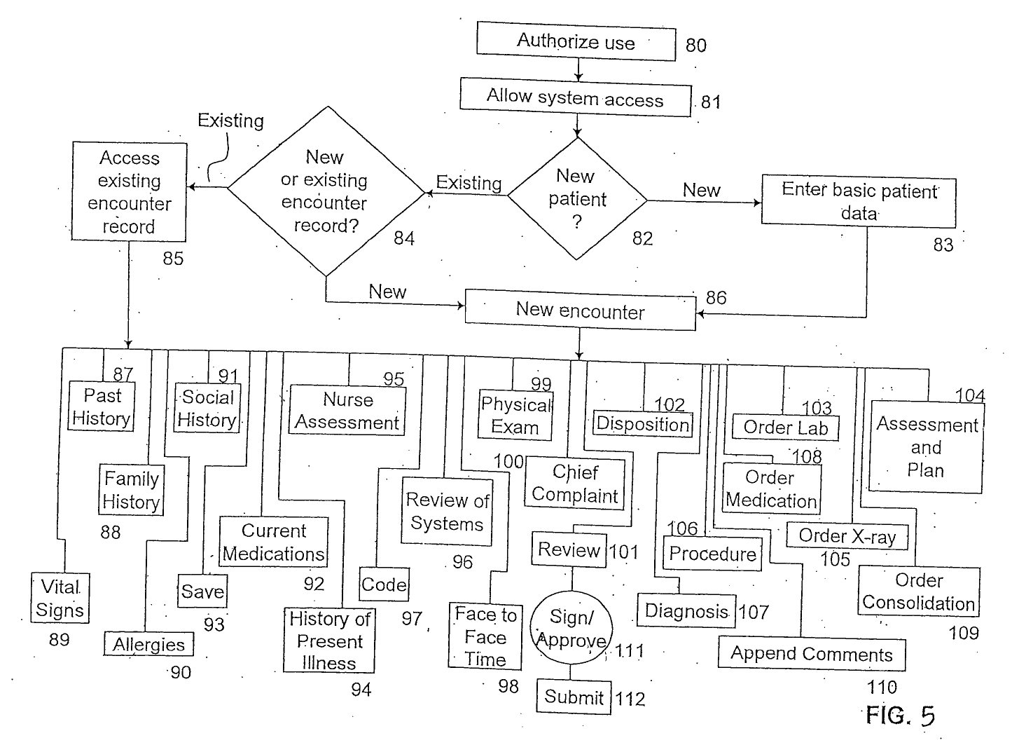

FIG. 5 is a flowchart illustrating an ontology based method of data capture and knowledge representation in the context of a medical patient encounter. A system such as the one previously described is assumed in this example. A first healthcare practitioner (e.g., a nurse) begins a patient evaluation by speaking a system use authorization command word or phrase into his/her wireless microphone (80). (Hereafter, the term “command word” will be used to mean both single words and short command phrases). This command word might be as simple as, “BEGIN”, or might require a more extensive expression, “THIS IS NURSE JANE DOE, AUTHORIZATION CODE 12345.” Voice recognition software in the staging block allows access to the system in response to a properly given authorization command word (81). Alternatively or additionally, biometrics or simple passwords might be used to control access to the system.

Next, the nurse speaks one of two command words, “NEW PATIENT” or “EXISTING PATIENT” (82). If the new patient command is given, the system responds by creating a new record and (optionally) displaying grouped data elements for the new record on a PDA (or other the staging block-associated display) in the examination room.

The term “grouped data elements” is used to describe any visual user feedback mechanism designed to aid the user in the entry of data. In one embodiment, grouped data elements may resemble a data entry template or form visually communicating to a user which data fields have already been addressed. However, the optional use of grouped data elements as a visual feedback mechanism in the invention should not be construed as a requirement by the invention to “lock-in” data entry to a predefined form or sequence. Indeed, embodiments of the invention are designed to provide complete freedom of data entry, and a nurse or physician may navigate the data entry options (and optionally associated grouped data elements) at will, and in a non-linear fashion. Thus, while certain grouped data elements may be used to conveniently facilitate the organized retrieval, review and/or entry of data, they do not constrain the system user to a particular flow of data entry or sequence in patient evaluation. For example, a healthcare practitioner could detail a patient's vitals signs, immediately proceed to an Assessment and Plan, instantly navigate back to a Review of Systems, etc. without having to re-orient the application. The control grammar functionality within the Syntax Processing Block differentiates between commands, scalar values, and paragraph-based prose, and allows for non-sequential navigation.

Returning to the flowchart of FIG. 5, for example, grouped data elements corresponding to basic patient data (e.g., name, age, address, health insurance, etc.) may be displayed to aid the nurse in proper creation of a new patient record (83). Of course, it is not required that a nurse enter the basic patient data or initiate a new patient record. A receptionist or even the patient may be given limited access to the system to manually and/or verbally enter this data.

Existing patients fall into one of two categories; those with an exiting (current) encounter record (84=existing) and those requiring initiation of a new encounter record (84=new). This distinction is required since embodiments of the invention contemplate multiple healthcare practitioners accessing a common patient encounter record. Thus, a first healthcare practitioner seeing the patient will indicate a “new encounter” and a corresponding new encounter record will be formed in response to appropriate command words (86). Second and subsequent healthcare practitioners seeing the patient during an encounter will indicate “an existing encounter record” (e.g., by number or patient name) using an appropriate command word, whereupon the system will call-up the existing encounter record (85).

With an encounter record properly called-up, the healthcare practitioner is ready to begin a free-form patient evaluation. The multiple parallel paths illustrated in the flowchart of FIG. 5 are merely a selected collection of examples. Any number of patient evaluation options may be included consistent with the scope of the medical practice, patient type, etc. Further, as previously indicated, the patient evaluation options provided by a system may be traversed in any manner, with or without the aid of a control grammar and/or grouped data elements.

However, continuing with the working example, the nurse preferably performs a nurse assessment (95) which may or may not include; taking a patient history (past 87, family 88, or social 89), querying the patient on allergies (90) and/or current medications (92). The nurse assessment may include taking the patient's vital signs (89), discussing the patient's chief complaint (100), and/or discussing the history of the present illness (94). Each one of these general patient evaluation options may be independently undertaken in response to a spoken command word or manual data input. Within each option, free-form text may be input to one or more text box(es) associated with a grouped data element displayed in response to the command word or manual data input.

At some point following the completion of his/her assessment, the nurse may indicate face-to-face time spent with the patient (94), and then will save the accumulated patient evaluation data (93).

Once the nurse has completed his/her portion of the patient evaluation, a second healthcare practitioner (e.g., a physician) may continue the evaluation. The second healthcare practitioner authorizes use of the system (80), is given access (81), and accesses the existing encounter record (84=existing and 85). Here again, the second healthcare practitioner's use of the system is largely if not entirely unconstrained in its flow. However, the system may also demand that certain criteria be addressed during the patient evaluation by one or more of the healthcare practitioners. For example, the second healthcare practitioner may be required at some point during his portion of the patient evaluation to review and/or approve the nurse assessment. The patient evaluation may require a redundant entry of critical data, such as allergies, current medications, etc.

Nonetheless, the second healthcare practitioner may conduct his/her patient evaluation with his/her unique flow, vocabulary style, and manner—so long as established criteria are ultimately addressed. During a second healthcare practitioner portion of the patient evaluation, the second healthcare practitioner may conduct a review of systems (96), perform a physical examination (99), state a diagnosis (107), summarize a disposition (102), prescribe or perform a procedure (106), or record an assessment and plan (104). The system also provides a healthcare practitioner with the ability to order medications (108), x-rays (105), labs (103), and additional consultations (109).

Following completion of his/her evaluation, the second healthcare practitioner may review the patient encounter record or some portion of it (101), approve (i.e., sign) it (111) and submit it (112). Either before or after the patient encounter record is approved and submitted, the system may code (97) the encounter record for billing purposes. Should a healthcare practitioner desire to add explanatory or corrective information to a submitted encounter record, a comments note may be appended to the encounter record (110).

The working example is drawn in part to the generation of accurate healthcare billing codes corresponding to a patient encounter. Thus, a complete, corrected data file is sent from the syntax processing block to the ontology processing block, where a competent ontology identifies all pertinent and/or possible healthcare billing codes corresponding to the patient encounter. The healthcare billing codes may be communicated in real time to a healthcare practitioner's PDA for review and approval (e.g., digitally signing and ending the session). Alternatively, a summary of healthcare billing codes may be sent to the healthcare practitioner at the end of the day for his/her review and approval (i.e., a batch feedback mode as opposed to a real time feedback mode).

Beneficially, a partially completed healthcare services claim form (e.g., CMS-1450; HCFA-1500) may be created using the generated healthcare billing codes. Optionally, the partially completed healthcare services claim form may be communicated in real time to a healthcare practitioner's PDA for review and approval (e.g., digitally signing and ending the session). Alternatively, a group of partially completed healthcare services claim forms may be sent to the healthcare practitioner at the end of the day for his/her review and approval (i.e., a batch feedback mode as opposed to a real time feedback mode).

While the system is preferably designed in many embodiments to provide maximum flexibility to a healthcare practitioner's evaluation style, it need not be only a passive data receiver. In addition to the optional use of command words, grouped data element feedback mechanisms, and criteria based correction mechanisms, the system may be designed to be interactive in real time with a user.

In response to key words or concepts extracted from the entry of patient evaluation data, the system may optionally suggest (or require) the collection of supplemental information regarding the patient. For example, if the patient complains of “being tired and thirsty all the time” during a nurse assessment, the system may prompt the nurse to inquire regarding a history of diabetes in the patient's family. The system may thereafter flag a consultation page in the patient's encounter record with a highlighted note of “POSSIBLE DIABETES” upon submission of the nurse's assessment. This highlighted note will be seen by the second healthcare practitioner as he/she begins his/her portion of the patient evaluation. Additionally, the indication of possible diabetes may be used by the syntax processing block to identify and/or further refine a lexicon of medical terminology likely to be used by a subsequent healthcare practitioner during his portion of the patient evaluation. (This is one example of feedback from the ontology processing block to the syntax processing block).

As noted above, the foregoing example may incorporate a voice enabled application incorporating a control grammar. The control grammar allows a system user to navigate a potentially complex series of tasks using only his or her voice. A hierarchy of command words (and possible synonyms) may be constructed to allow logical progression through a patient evaluation. For example, a sequence of specific vital signs may be obligatorily or optionally implicated once the command word “VITALS” is spoken (e.g., temperature, blood pressure, pulse, height, weight, etc.).

Indeed, any number of subordinated command word menus may be used during each option and phase of a patient evaluation. Certain critical command words, such as “allergies” and “current medications” may be designated for mandatory inclusion in all patient evaluations.

The working example is drawn in part to the preparation of accurate healthcare billing codes corresponding to a patient evaluation. Thus, a complete, corrected data file is sent from the syntax processing block to the ontology processing block, where a competent ontology identifies all pertinent and/or possible healthcare billing codes corresponding to the patient evaluation.

The standardized healthcare billing code output generated by the ontology processing block, as well as the corrected data file stored in a data base associated with the ontology processing block may thereafter be linked to various files (external or internal to the system). For example, laboratory results from laboratory tests order in the patient evaluation may be linked and correlated with the corrected data file stored in the system. Similarly, a patient scheduling application determining a follow-up visit or a pharmacy ordering application placing a prescription request may be automatically implicated as a result of the corrected data file's contents, and/or an ontology processing block response to the corrected data file.

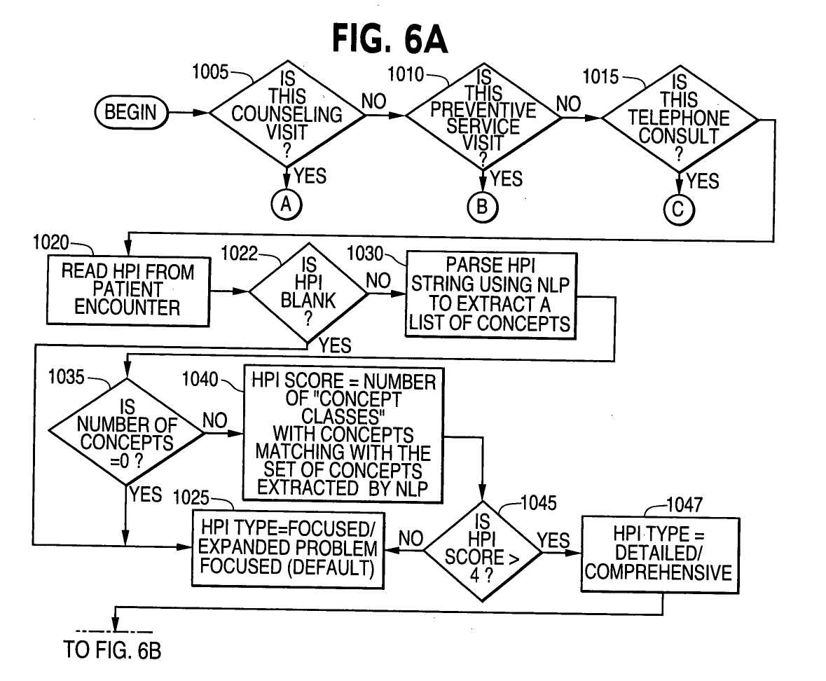

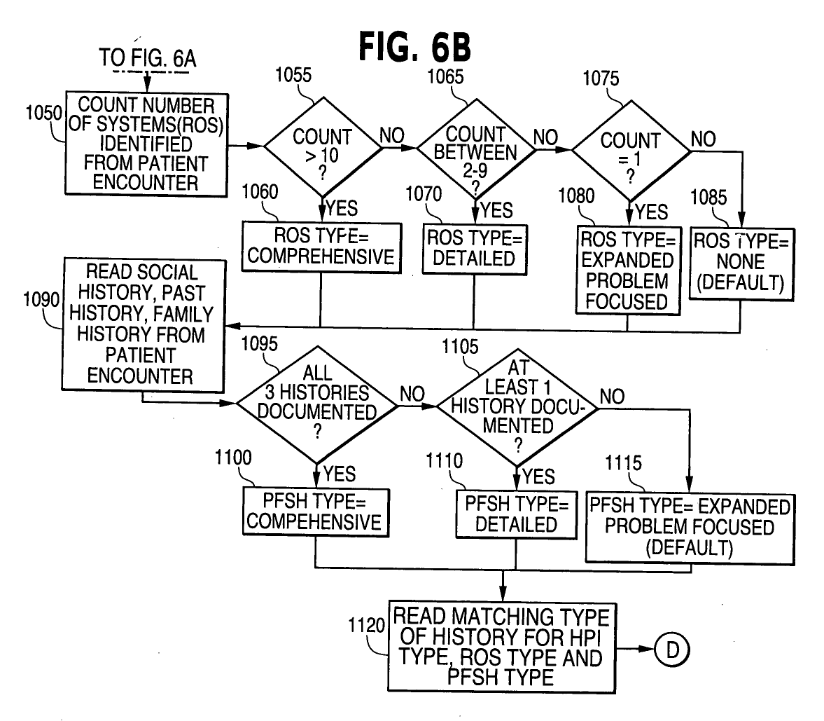

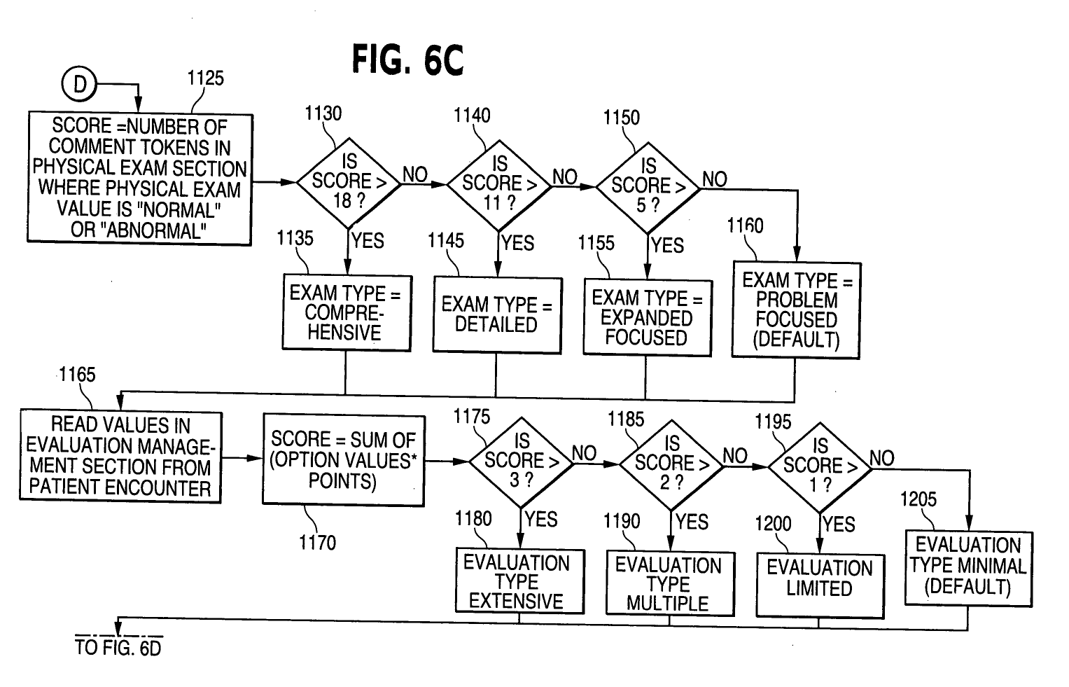

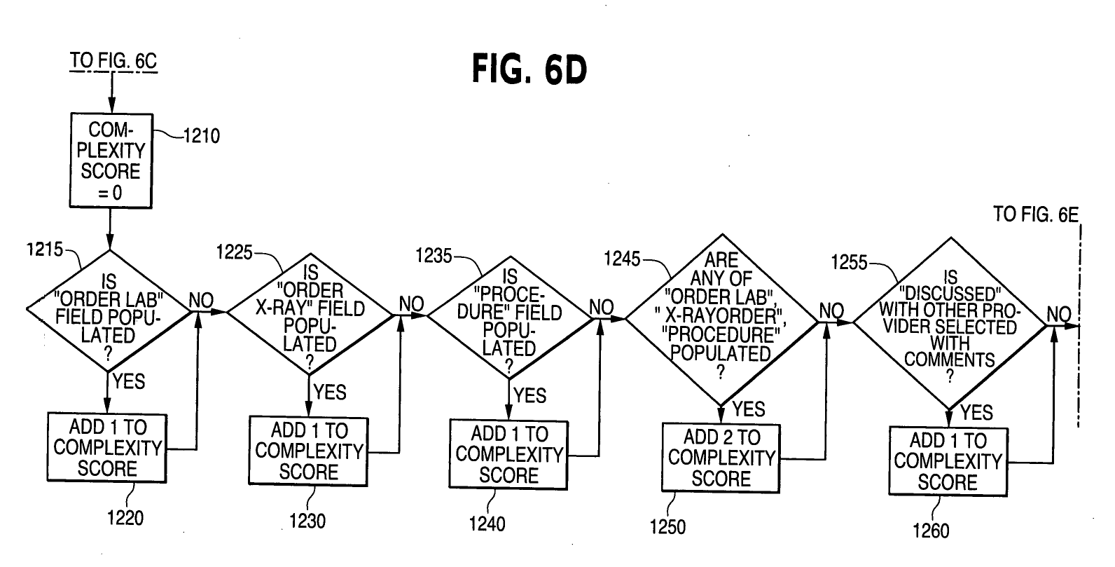

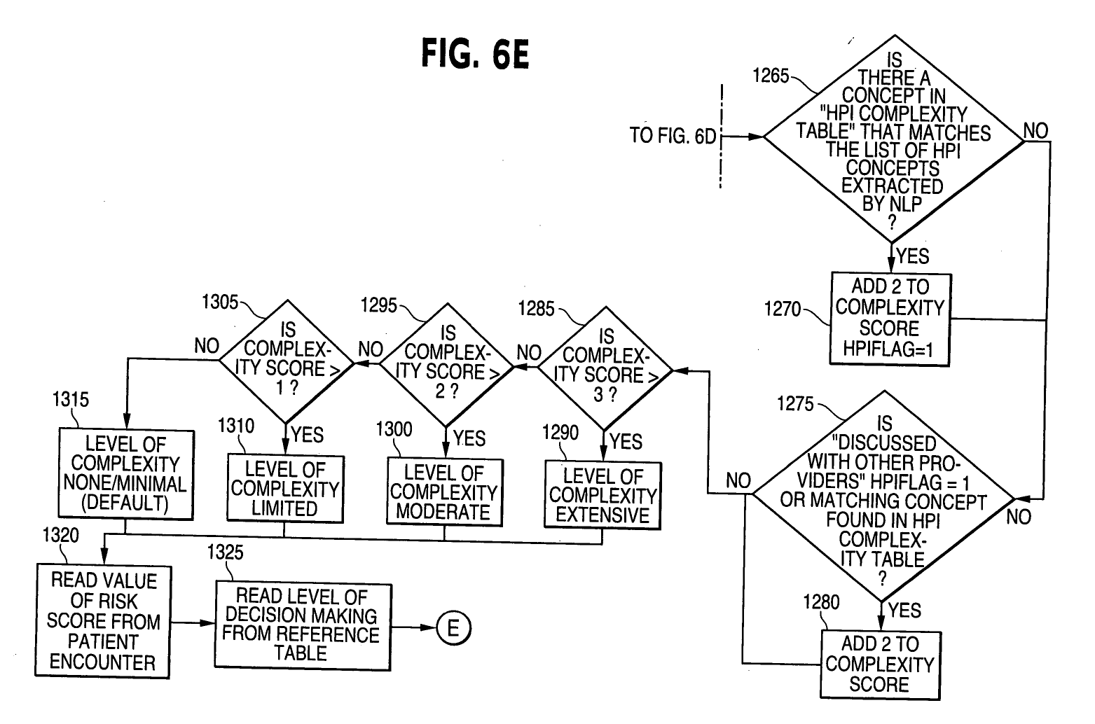

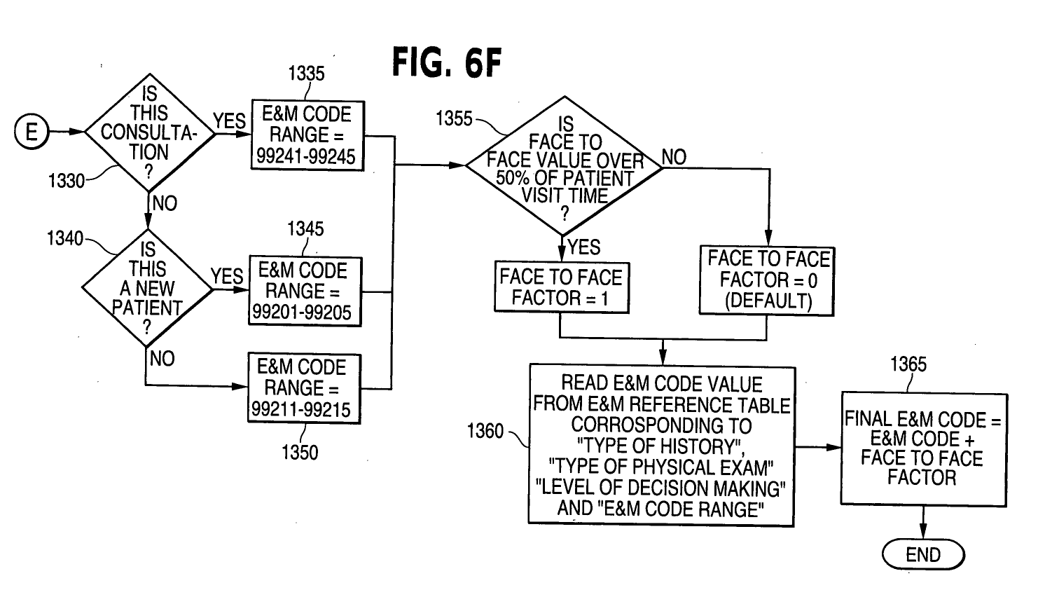

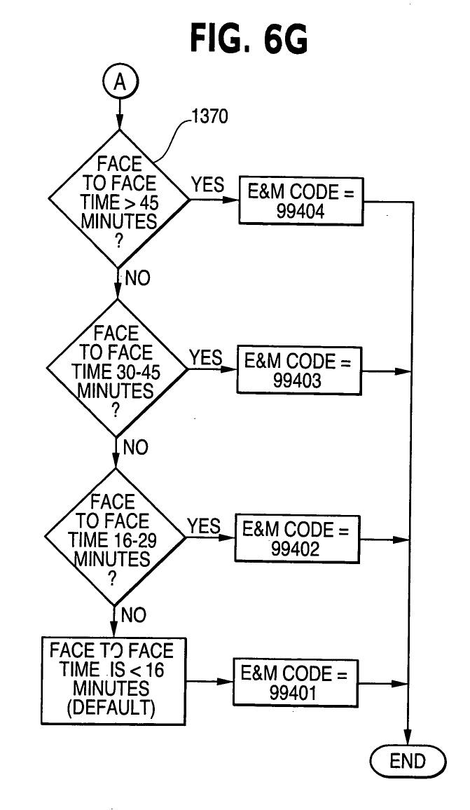

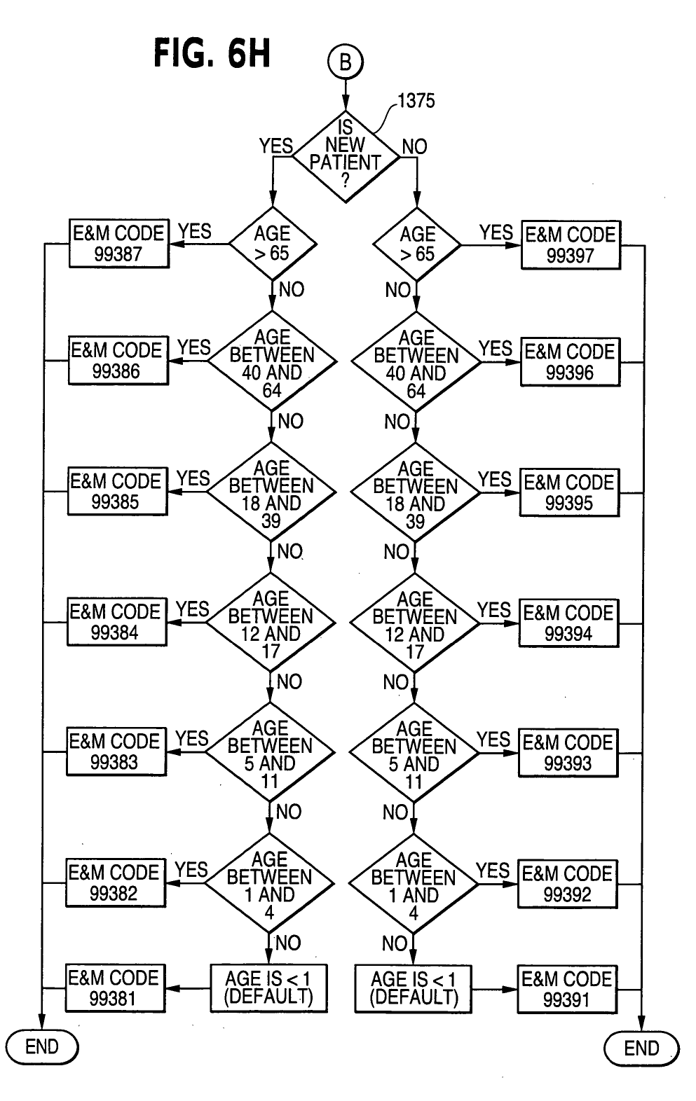

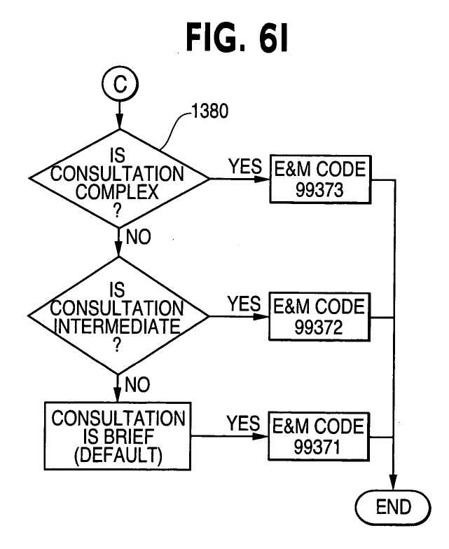

FIGS. 6A-F are flowcharts further illustrating on embodiment of a process of generating healthcare billing codes from a corrected data file produced from a patient encounter. In particular, FIGS. 6A-F illustrate an embodiment of a coding decision process of a medical billing ontology operating on a corrected data file generated from a patient encounter in order to generate one class of CMT billing codes known as Evaluation and Management (E&M) Codes.

Referring to FIG. 6A, in step 1005 the ontology determines whether the patient encounter is a counseling visit. If so, the process continues at step 1370 shown in FIG. 6D, discussed below. If not, the process proceeds to step 1010 where it is determined whether the patient encounter is a preventive service visit. If so, the process continues at step 1375 shown in FIG. 6E, discussed below. If not, the process proceeds to step 1015 where it is determined whether the patient encounter is a telephone consultation. If so, the process continues at step 1380 shown in FIG. 6F, discussed below.

If not, the process proceeds to step 1020 where a history of present illness (HPI) is generated from the corrected data file for the patient encounter. The HPI is a chronological description of the present illness, from the first sign or symptom or from a previous encounter to the present. In step 1022, if the HPI is blank then in a step 1025 the HPI type is set to be “Problem Focused/Expanded Problem Focused,” and the process proceeds to step 1050. Otherwise, in step 1030, the HPI string is parsed using, for example, natural language processing (NLP) to extract a list of concepts defined in the ontology. Then, in a step 1035, if the number of concepts is zero, then the HPI type is set to be “Problem Focused/Expanded Problem Focused,” and the process proceeds to step 1050. If the number of concepts is greater than zero, then in step 1040 an HPI Score is assigned. Beneficially, the HPI score equals the number of concepts extracted by the NLP that match a defined set of concept classes. In a step 1045, if the HPI score is less than or equal to four (4), then the HPI type is set to be “Problem Focused/Expanded Problem Focused,” and the process proceeds to step 1050. Otherwise, in a step 1047 the HPI type is set to be “Detailed/Comprehensive,” and the process proceeds to step 1050.

In the step 1050, the number of Review of Systems (ROS) identified from the corrected data file for the patient encounter is counted. An ROS is a listing of signs or symptoms the patient may be experiencing or has experienced, organized by body system. In a step 1055, it is determined if the ROS count is greater than 10. If so, then in a step 1060 the ROS Type is set to “Comprehensive,” and the process proceeds to step 1090. Otherwise, in step 1065, it is determined if the ROS count is between two and nine. If so, then in a step 1070 the ROS Type is set to “Detailed,” and the process proceeds to step 1090. Otherwise, in step 1075, it is determined if the ROS count is one. If so, then in a step 1080 the ROS Type is set to “Expanded Problem Focused,” and the process proceeds to step 1090. Otherwise, in step 1085, the ROS Type is set to “None,” and the process proceeds to step 1090.

In the step 1090, Past Personal, Family, and/or Social History (PFSH) is generated from the corrected data file for the patient encounter. The PFSH includes past personal history (e.g., prior illnesses/injuries, prior operations, allergies, etc.) family history (e.g., members living, health status, hereditary conditions, etc.), and social history (e.g., marital status, employment, tobacco use, drug use, etc.). In a step 1095, it is determined whether all three histories were documented during the patient encounter. If so, then in a step 1100 the PFSH Type is set to “Comprehensive,” and the process proceeds to step 1120. Otherwise, in step 1105, it is determined if at least one history is documented. If so, then in a step 1110 the PFSH Type is set to “Detailed,” and the process proceeds to step 1120. Otherwise, in step 1115, the PFSH Type is set to “Expanded Problem Focused.”

Next, in a step 1120, a “Type of History” is determined from the HPI Type, ROS Type, and PFSH type determined in the preceding steps. Beneficially, a look-up table may be used to determined the “Type of History,” which may be assigned a value of “Comprehensive,” “Detailed,” “Expanded Problem Focused,” or “Problem Focused.” Then the process proceeds to step 1125, shown in FIG. 6B.

In the step 1125, a number of comment tokens in the physical examination section of the corrected data file are counted where the value is “normal” or “abnormal” are counted to produce an examination score. In a step 1130, it is determined whether the examination score is greater than 18. If so, then in a step 1135, the Exam Type is set to “Comprehensive,” and the process proceeds to step 1165. Otherwise, in step 1140, it is determined if the examination score is greater than 11. If so, then in a step 1145 the Exam Type is set to “Detailed,” and the process proceeds to step 1165. Otherwise, in step 1150, it is determined if the examination score is greater than five. If so, then in a step 1155 the Exam Type is set to “Expanded Problem Focused,” and the process proceeds to step 1165. Otherwise, in step 1160, the Exam Type is set to “Problem Focused.”

In the next step 1165, problem categories are generated from an Evaluation/Management section of a corrected data file for a patient encounter. Then, in step 1170, an evaluation score is determined by adding together a points-weighted number of problem categories identified. Beneficially, the evaluation score may be determined in accordance with CPT Guidelines. Then, in a step 1175, it is determined whether the evaluation score is greater than three. If so, then in a step 1180, the Evaluation Type is set to “Extensive,” and the process proceeds to step 1210. Otherwise, in step 1185, it is determined if the evaluation score is greater than two. If so, then in a step 1190 the Evaluation Type is set to “Multiple,” and the process proceeds to step 1210. Otherwise, in step 1195, it is determined if the evaluation score is greater than one. If so, then in a step 1200 the Evaluation Type is set to “Limited,” and the process proceeds to step 1210. Otherwise, in step 1205, the Evaluation Type is set to “Minimal.”

In the next step 1210, a complexity score is initially set to zero. Then, in step 1215 it is determined whether an “Order Lab” field is populated in the corrected data file from the patient encounter. If so, then in a step 1220, the complexity score is incremented by one. Then the process proceeds to step 1225. In step 1225, it is determined whether an “Order X-Ray” field is populated in the corrected data file from the patient encounter. If so, then in a step 1230, the complexity score is incremented by one. Then the process proceeds to step 1235. In step 1235, it is determined whether a “Procedure” field is populated in the corrected data file from the patient encounter. If so, then in a step 1240, the complexity score is incremented by one. Then the process proceeds to step 1245. In step 1245, it is determined whether any of the “Order X-Ray,” “Order Lab” or “Procedure” fields are populated in the corrected data file from the patient encounter. If so, then in a step 1250, the complexity score is incremented by two. Then the process proceeds to step 1255. In step 1255, it is determined whether a “Discussed with Other Providers” field is populated in the corrected data file from the patient encounter. If so, then in a step 1260, the complexity score is incremented by one. Then the process proceeds to step 1265. In step 1265, it is determined whether there is a concept extracted by NLP from the corrected data file from a patient encounter that matches a concept in an HPI Complexity Table of the ontology. If so, then in a step 1270, the complexity score is incremented by one. Then the process proceeds to step 1275. In step 1275, it is determined whether either the “Discussed with Other Providers” field is populated or there is a concept extracted by NLP from the corrected data file from a patient encounter that matches a concept in an HPI Complexity Table of the ontology. If so, then in a step 1280, the complexity score is incremented by two. Then the process proceeds to step 1285. 0087 in the step 1285, it is determined whether the complexity score is greater than three. If so, then in a step 1290 the Level of Complexity is set to “Extensive,” and the process proceeds to step 1320. Otherwise, in step 1295, it is determined if the complexity score is greater than two. If so, then in a step 1300 the Level of Complexity is set to “Moderate,” and the process proceeds to step 1320. Otherwise, in step 1305 it is determined if the complexity score is greater than one. If so, then in a step 1310 the Level of Complexity is set to “Limited,” and the process proceeds to step 1320. Otherwise, in step 1315 the Exam Type is set to “None/Minimal,” and the process proceeds to step 1320.

In the step 1320, a Risk value is obtained from the corrected data file from the patient encounter.

Next, in a step 1325, a Level of Decision Making is determined based on the previously-set values for the Evaluation Type, Level of Complexity, and Risk. Beneficially, the Level of Decision Making may be determined according to CPT Guidelines. Then the process proceeds to step 1330, shown in FIG. 6C.

In the step 1330, it is determined whether the patient encounter is a consultation. If so, then in a step 1335, the E&M Code Range is set to be in the range 99241-99245, and the process proceeds to step 1355. Otherwise, in a step 1340, it is determined whether the patient encounter is for a new patient. If so, then in a step 1345, the E&M Code Range is set to be in the range 99201-99205, and the process proceeds to step 1355. Otherwise, in a step 1350, the E&M Code Range is set to be in the range 99211-99215, and the process proceeds to step 1355.

In the step 1355 it is determined from the corrected data file whether the face-to-face value of the patient encounter is greater than 50% of the patient visit time. If so, then the Face-to-Face value is set to one. Otherwise, the Face-to-Face value is set to zero. Then the process proceeds to step 1360.

In step 1360, a preliminary E&M Code is obtained from an E&M Reference Table based on the previously-obtained values for the Type of History, Type of Physical Exam, Level of Decision Making, and E&M Coding Range.

Finally, in a step 1365 a final E&M code is obtained by adding the Face-to-Face value to the preliminary E&M code.

Meanwhile, FIG. 6D shows the remainder of the process when it is determined in step 1305 that the patient encounter is a counseling visit. As shown in FIG. 6D, the E&M Code is generated based on the amount of face-to-face time in the patient encounter.

Also, FIG. 6E shows the remainder of the process when it is determined in step 1310 that the patient encounter is a preventive service visit. As shown in FIG. 6E, the E&M Code is generated based on whether the patient is a new patient, and based on the patient's age.

Finally, FIG. 6F shows the remainder of the process when it is determined in step 1315 that the patient encounter is a telephone consult. As shown in FIG. 6F, the E&M Code is generated based on the complexity of the consultation.

Accordingly, as a result of a process such as the embodiment of FIGS. 6A-F described in detail above, a medical billing ontology may operate on a corrected data file produced from a patient encounter to generate an Evaluation and Management (E&M) Code as a standardized output. Similarly, other billing codes (e.g., one or more other billing codes shown in Table 1), and additional data may be output by the ontology in a standardized form. As noted above, the ontology may output the billing code(s) and may combine additional data in standardized form as a partially completed standard healthcare services claim form for finalization and approval by the appropriate healthcare professional.

Although the embodiments and discussion above has focused principally on the context of a patient encounter with a medical healthcare provider, such as a physician, the principles are not so limited. These principles are equally applicable to patient encounters with dental healthcare providers to generate billing codes conforming to Current Dental Terminology, Zth edition (CDT-Z), where Z≧4, and patient encounters with optometrists and ophthalmologists to generate Eye Exam and Treatment codes. The principles may also be applied as appropriate for medical services provided outside a physician's office, such as ambulance services, durable medical equipment, prosthetics, orthotics, and supplies (DMEPOS) to generate HCPCS Level II billing codes.

The foregoing embodiments describing various aspects of the invention may further include various optional yet related features. For example, the system might allow a user to interrupt (halt and save) a patient encounter before its completion, and thereafter allow the user to return to the point at which the encountered was interrupted—without the loss of previously entered data.

In another aspect, the system is adapted to provide a complete audit trail of the entire patient evaluation or encounter. Audit information may include all data entries, work orders, and tasks performed for each healthcare practitioner by name, date, and/or system identification. Where multiple healthcare practitioners make data entries to a common patient record during an encounter, each entry is marked or associated with the entering practitioner. In certain circumstances, changes or additions to a patient record may require an accompanying explanation to satisfy the system's auditing mechanism.

While several embodiments described above emphasize the possibility of hands-free operation, it should be noted that voice-only data entry will rarely be a desirable design alternative. Some capability to input data using traditional data inputs techniques (e.g., mouse, keyboard, or stylus activated menu options) will almost always be desirable to accommodate different practitioner styles and/or patient sensitivities.

Various system user feedback options have been described above, whereby a user is given to understand that some essential criteria of the patient record has been omitted or entered in error. Such user alerts may be visual and/or audible. However, audible alerts should be capable of being turned off to appropriately match the working environment.

In another aspect of the invention, completed and “signed” patient records are saved within the system in a non-modifiable format, using such techniques as read-only access, encrypted master copies, etc. Subsequent access to such records will allow only the addition of comments or linking to another patient record.

In yet another aspect, the healthcare billing codes (e.g., Evaluation and Management “E&M” codes from the CPT standard) are preferably subject to mandatory review by an authorizing healthcare practitioner prior to completion and signing of a patient record. Further, changes to healthcare billing codes provided by the ontology processing block are noted as exceptions and preferably feedback to the ontology processing block as system learning information to be considered during ontology quality control and/or maintenance procedures.

In yet another aspect of the invention, multiple externally provided records may be appended or linked with a patient record, including images and schemas.

In the foregoing examples, the term “record” is used to describe the documentary results of a patient examination. This term is intended to be very broad and it encompasses much more than the subject matter of the traditional (hand-written) patient record. Any patient report or file might be considered a record for purposes of this description.

Those of ordinary skill in the art will recognize that many modifications and adaptations may be made to the foregoing embodiments, and that the principles taught in relation to the invention may be applied to different fields of endeavor. In sum, the embodiments are examples. The scope of the invention is defined by the attached claims.

What is claimed:

1. A method of generating healthcare billing codes, comprising:
receiving non-standard data produced during a patient encounter with a healthcare provider;
processing the non-standard data in a syntax processing block and generating a corrected data file with reference to a healthcare lexicon; and,
receiving the corrected data file in an ontology processing block and, in response to the corrected data file, generating standardized output data including one or more healthcare billing codes associated with the patient encounter.

2. The method of claim 1, wherein generating one or more healthcare billing codes includes generating at least one of a medical diagnosis code and a healthcare procedure code.

3. The method of claim 2, wherein generating one or more healthcare billing codes includes generating at least one healthcare procedure code belonging to a set of healthcare procedure codes of Current Procedure Terminology, Yth edition, where Y≧4.

4. The method of claim 3, where the healthcare procedure code is an Evaluation & Management (E&M) code.

5. The method of claim 2, wherein generating one or more healthcare billing codes includes generating a medical diagnosis code belonging to a set of diagnosis codes of the International Classification of Diseases, Xth edition, Clinical Modification, where X≧9.

6. The method of claim 1, wherein generating standardized output data includes generating a healthcare services claim form that is at least partially completed.

7. The method of claim 6, where the healthcare service claim form is one of a CMS-1450 and a HCFA-1500 claim form.

8. The method of claim 6, where generating a healthcare services claim form that is at least partially completed includes entering in the claim form an Evaluation & Management (E&M) code belonging to a set of E&M codes of Current Procedure Terminology, Yth edition, where Y≧4.

9. The method of claim 1, wherein the non-standard data comprises voice data, and the syntax processing block comprises a speech recognition application associated with the healthcare lexicon.

10. The method of claim 1, wherein the non-standard data comprises handwriting, and the syntax processing block comprises a handwriting recognition application associated with the healthcare lexicon.

11. The method of claim 1, wherein the non-standard data comprises text data, and the syntax processing block comprises a forms recognition application.

12. The method of claim 1, wherein the non-standard data comprises an electronic file, and the syntax processing block comprises a file parsing application.

13. The method of claim 1, wherein the non-standard data comprises at least one of voice, handwriting, text, image data, and an electronic file, and wherein the syntax processing block comprises at least one of a voice recognition application, a forms recognition application, an image recognition application, and a file parsing application associated with the healthcare lexicon.

14. The method of claim 1, wherein the syntax processing block comprises a capture block and a staging block, the method comprising:
receiving the non-standard data in the capture block; and
wirelessly communicating the non-standard data to the staging block.

15. The method of claim 14, wherein the capture block comprises a wireless microphone, and wherein the staging block comprises a digital logic platform, and wherein wirelessly communicating the non-standard data from the capture block to the staging block comprises generating a voice transcript signal in the wireless microphone, the method further comprising:
generating the corrected data file in the digital logic platform in response to the voice transcript signal and with reference to the healthcare lexicon.

16. The method of claim 15, wherein the digital logic platform comprises a Personal Computer (PC), a tablet PC, a laptop PC, or Personal Digital Assistant (PDA), or other transportable computing hardware.

17. The method of claim 15, wherein generating the corrected data file in the digital logic platform comprises:
running a capture application enabling receipt of the voice transcript signal and generation of a voice data file from the voice transcript signal;
running a syntax application generating the corrected data file from the voice data file; and
running an interface application allowing reference to the healthcare lexicon by the capture application or the syntax application.

18. The method of claim 17, wherein the syntax application comprises a subroutine correcting components in the voice data file with reference to the healthcare lexicon.

19. The method of claim 17, wherein the syntax application comprises a subroutine correcting the voice data file in accordance with a criteria.

20. The method of claim 17, wherein the syntax application comprises one subroutine correcting components in the voice data file with reference to the healthcare lexicon and another subroutine correcting the voice data file in accordance with a criteria.

21. The method of claim 1, wherein the ontology processing block comprises a database or other persistent data storage mechanism, and a server, the method further comprising:
saving the corrected data file in the database or other persistent data storage mechanism.

22. The method of claim 1, wherein generating the standardized output comprises:
running an ontology application on the server adapted to reference an ontology in relation to the corrected data file.

23. The method of claim 1, wherein the standardized output is standardized in relation to at least one of: Health Insurance Portability & Accountability Act (HIPAA) standard; a Health Care Procedures Coding System (HCPCS) standard; Systematized Nomenclature of Medicine—Clinical Terms (SNOMED CT); International Classification of Diseases: X^{th} revision, Clinical Modification (ICD-X-CM) standard, where X≧9; Current Procedural Terminology (CPT-Y) standard, where Y≧4; Health Level 7 (HL7); a Digital Imaging and Communications in Medicine (DICOM) standard; a Food & Drug Administration (FDA) standard; a Veterans Affairs (VA) standard; a National Library of Medicine (NLM) standard; a Health and Human Services (HHS) standard; a Centers of Medicare and Medicaid Services (CMS) standard, or a World Health Organization (WHO) standard.

24. The method of claim 1, wherein the corrected data file is communicated from the syntax processing block to the ontology processing block via a Wireless Local Area Network (WLAN), a Wireless Metropolitan Area Network (WMAN), an ad-hoc wireless network, a hardwired Local Area Network (LAN), or an Ethernet connected network.

25. A method, comprising:
receiving with a wireless microphone system non-standard voice input data relating to a patient encounter, and in response thereto generating a voice transcript signal;
wirelessly communicating the voice transcript signal to a digital logic platform and generating a corrected data file in response to the voice transcript signal and with reference to a healthcare lexicon;
communicating the corrected data file to a server;
referencing an ontology in relation to the corrected data file; and,
generating a standardized output, including one or more healthcare billing codes, in response to the referencing of the ontology in relation to the corrected data file.

26. The method of claim 25, wherein generating one or more healthcare billing codes includes generating at least one of a medical diagnosis code and a healthcare procedure code.

27. The method of claim 26, wherein generating one or more healthcare billing codes includes generating at least one healthcare procedure code belonging to a set of healthcare procedure codes of Current Procedure Terminology, Yth edition, where Y≧4.

28. The method of claim 27, where the healthcare procedure code is an Evaluation & Management (E&M) code.

29. The method of claim 26, wherein generating one or more healthcare billing codes includes generating a medical diagnosis code belonging to a set of diagnosis codes of the International Classification of Diseases, Xth edition, Clinical Modification, where X≧9.

30. The method of claim 25, wherein generating standardized output data includes generating a healthcare services claim form that is at least partially completed.

31. The method of claim 30, where the healthcare service claim form is one of a CMS-1450 and a HCFA-1500 claim form.

32. The method of claim 30, where generating a healthcare services claim form that is at least partially completed includes entering in the claim form an Evaluation & Management (E&M) code belonging to a set of E&M codes of Current Procedure Terminology, Yth edition, where Y≧4.

33. The method of claim 25, where the server is adapted to communicate the healthcare billing code to the digital logic platform for review.

34. The method of claim 25, wherein generating the corrected data file in response to the voice transcript signal comprises:
running a voice enabled application establishing a control grammar controlling receipt of the voice input data, and an audio, visual, or both acknowledgement of the voice input data.

35. The method of claim 25, wherein the standardized output is standardized in relation to at least one of: Health Insurance Portability & Accountability Act (HIPAA) standard; a Health Care Procedures Coding System (HCPCS) standard; Systematized Nomenclature of Medicine—Clinical Terms (SNOMED CT); International Classification of Diseases: X^{th} revision, Clinical Modification (ICD-X-CM) standard, where X≧9; Current Procedural Terminology (CPT-Y) standard, where Y≧4; Health Level 7 (HL7); a Digital Imaging and Communications in Medicine (DICOM) standard; a Food & Drug Administration (FDA) standard; a Veterans Affairs (VA) standard; a National Library of Medicine (NLM) standard; a Health and Human Services (HHS) standard; a Centers of Medicare and Medicaid Services (CMS) standard, or a World Health Organization (WHO) standard.

36. A method, comprising:
receiving non-standard voice input data produced as a result of a patient encounter with a healthcare provider;
processing the non-standard voice input data through a syntax processing block to generate a corrected data file with reference to a healthcare lexicon; and
processing the corrected data file with reference to a billing code ontology to generate standardized output data including at least one healthcare billing code pertaining to the patient encounter.

37. The method of claim 36, wherein processing the non-standard voice input data includes performing a speech recognition algorithm on the voice input data with reference to the healthcare lexicon.

38. The method of claim 37, further comprising receiving user feedback to an output of the speech recognition algorithm.

39. The method of claim 38, further comprising further correcting the output of the speech recognition algorithm to produce the corrected data file.

40. The method of claim 36, wherein generating one or more healthcare billing codes includes generating at least one of a medical diagnosis code and a healthcare procedure code.

41. The method of claim 40, wherein generating one or more healthcare billing codes includes generating at least one healthcare procedure code belonging to a set of healthcare procedure codes of Current Procedure Terminology, Yth edition, where Y≧4.

42. The method of claim 41, where the healthcare procedure code is an Evaluation & Management (E&M) code.

43. The method of claim 40, wherein generating one or more healthcare billing codes includes generating a medical diagnosis code belonging to a set of diagnosis codes of the International Classification of Diseases, Xth edition, Clinical Modification, where X≧9.

44. The method of claim 36, wherein generating standardized output data includes generating a healthcare services claim form that is at least partially completed.

45. The method of claim 44, where the healthcare service claim form is one of a CMS-1450 and a HCFA-1500 claim form.

46. The method of claim 44, where generating a healthcare services claim form that is at least partially completed includes entering in the claim form an Evaluation & Management (E&M) code belonging to a set of E&M codes of Current Procedure Terminology, Yth edition, where Y≧4.
